(19) United States
(12) Patent Application Publication
(10) Pub. No.: US 2025/0247485 A1
(43) Pub. Date: Jul. 31, 2025

(54) IMAGE FORMING APPARATUS AND METHOD FOR CONTROLLING IMAGE FORMING APPARATUS

(71) Applicant: SHARP KABUSHIKI KAISHA, Osaka (JP)

(72) Inventor: AKIHITO YOSHIDA, Osaka (JP)

(21) Appl. No.: 19/036,593

(22) Filed: Jan. 24, 2025

(30) Foreign Application Priority Data
Jan. 31, 2024 (JP) 2024-013295

(51) Int. Cl. H04N 1/387

(52) U.S. Cl. CPC H04N 1/3877

(57) ABSTRACT

An image forming apparatus includes one or more controllers; an image inputter that optically reads a document; and a document transporter that transports the document, wherein the one or more controllers generate a document image obtained by creating an image of the document after the image inputter reads the document while the document transporter transports the document, specify a mapping function correlating each coordinate of the document with each coordinate of the generated document image, and correct a distortion of the document image by transforming the document image for the mapping function.

### CROSS-REFERENCE TO RELATED APPLICATION

The present application claims priority from Japanese Application JP 2024-013295, the content of which is hereby incorporated by reference into this application.

### BACKGROUND OF THE DISCLOSURE

### Field of the Disclosure

The present disclosure relates to a distortion of a scanned image produced by a scanner, and more particularly, to a distortion of a scanned image that occurs in a scanner including a document feeder.

### Description of the Related Art

In a scanner including a document feeder, when a document transported by the document feeder is scanned, a transportation state of the document may change due to slippage and the like of the document that occurs during a scanning process. Such changes in the transportation state may cause a distortion in a scanned image.

In relation to a distortion that occurs in a scanned image, there is a technique for generating an image by extracting a polygon defining the outline of the image, dividing the extracted polygon into a number of quadrangles, transforming each of the quadrangles into rectangles, and combining the transformed rectangles.

### SUMMARY OF THE DISCLOSURE

The problem to be solved by the present disclosure is to provide an image forming apparatus for generating a document image in which a distortion is corrected.

The present disclosure provides an image forming apparatus including a controller, an image inputter that optically reads a document, and a document transporter that transports the document, in which the controller generates a document image obtained by creating an image of the document after the image inputter reads the document while the document transporter transports the document, specifies a mapping function correlating each coordinate of the document with each coordinate of the generated document image, and corrects a distortion of the document image by transforming the document image for the mapping function corresponding to changes in a transport state.

The present disclosure also provides a method for controlling an image forming apparatus. The method includes generating a document image obtained by creating an image of a document after the document is read while being transported, specifying a mapping function correlating each coordinate of the document with each coordinate of the generated document image, and correcting a distortion of the document image by transforming the document image for the mapping function.

According to the present disclosure, it is possible to provide an image forming apparatus for generating a document image in which a distortion is corrected.

### BRIEF DESCRIPTION OF THE DRAWINGS

FIG. 1 is a functional block diagram of an image forming apparatus according to a first embodiment of the present disclosure.

FIG. 2 is a diagram for explaining a distortion that occurs in a scanned image when a document undergoes a uniform linear motion and a rotational motion simultaneously in a document transporter, and illustrates a case in which the distortion is small.

FIG. 3 is a diagram for explaining a distortion that occurs in a scanned image when a document undergoes a uniform linear motion and a rotational motion simultaneously in a document transporter, and illustrates a case in which the distortion is moderate.

FIG. 4 is a diagram for explaining a distortion that occurs in a scanned image when a document undergoes a uniform linear motion and a rotational motion simultaneously in a document transporter, and illustrates a case in which the distortion is large.

FIG. 5 is a diagram for explaining a simulation of occurrence of a distortion caused by a change in tilt angle of a document while transporting the document.

FIG. 6A is a diagram illustrating a business card sized image used as a document in the simulation of FIG. 5.

FIG. 6B is a diagram illustrating an image obtained by applying the simulation of FIG. 5 to the image in FIG. 6A.

FIG. 7 is a diagram for explaining various types of numerical values obtained by actually measuring a document image included in a scanned image.

FIG. 8 is a flowchart illustrating processing for sensing a document image from a scanned image.

FIG. 9 is a flowchart illustrating processing for extracting a correction processing parameter.

FIG. 10 is a diagram for explaining a relationship between image transformation and a mapping function.

FIG. 11 is a flowchart illustrating distortion correction processing according to the present disclosure.

FIG. 12 is a diagram for illustrating an example of a distorted scanned image.

FIG. 13 is a diagram for explaining a state in which rotation processing, which is a part of general correction processing, is applied to the scanned image in FIG. 12.

FIG. 14 is a diagram for explaining a corrected scanned image obtained by applying cropping processing, which is a part of general correction processing, to the scanned image applied with the rotation processing in FIG. 13.

FIG. 15 is a diagram for explaining an image obtained by applying the correction processing according to the present disclosure to the scanned image in FIG. 12.

### DETAILED DESCRIPTION OF THE DISCLOSURE

### 1. First Embodiment

### 1.1 Hardware Configuration

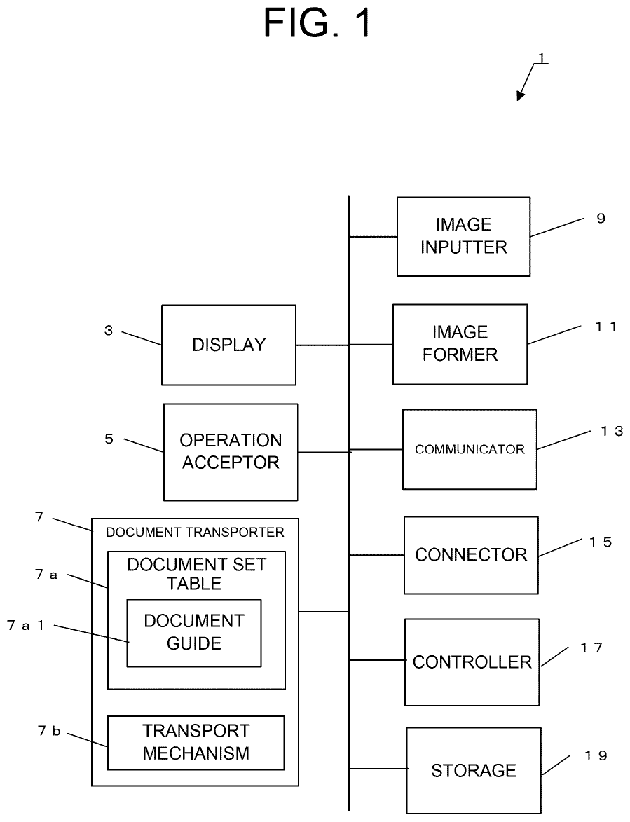

FIG. 1 is a functional block diagram of an image forming apparatus according to a first embodiment of the present disclosure. An image forming apparatus 1 is a Multi-Function Printer/Peripheral (MFP) or a multifunction machine, and typically has a copy function, an image scanner function, a facsimile function, and a printer function. The image forming apparatus 1 includes a display 3, an operation acceptor 5, a document transporter 7, an image inputter 9, an image former 11, a communicator 13, a connector 15, a controller 17, and a storage 19.

The display 3 displays an image and a character. For example, the display 3 includes a liquid crystal display (LCD) or an organic electro-luminescence (EL) panel. The display 3 may be a standalone display device, or may further include an externally connected display device.

The operation acceptor 5 accepts an operation input from a user. For example, the operation acceptor 5 includes a hardware key and/or a software key. The operation acceptor 5 also includes an operation key such as a task key for instructing execution of a task, such as fax transmission or image reading, and a stop key for instructing cancellation of an operation.

The document transporter 7 includes a document set table 7a and a transport mechanism 7b. The document set table 7a is a table for setting a sheet on which an image to be read by the image inputter 9 is drawn, that is, one or more documents. The document set table 7a includes a document guide 7al serving as a reference for a position to which the document is set. The transport mechanism 7b transports a document set on the document set table 7a to the image inputter 9, and ejects the document after the image is input by the image inputter 9.

The image inputter 9 reads an image formed on the surface of a document to output the image as image data (scanned image). The image inputter 9 includes a color scanner (image input device). The image inputter 9 includes a reading surface on which a document is placed. The reading surface is formed of a transparent plate-like member such as a glass plate. The image inputter 9 includes an image sensor, such as a charge coupled device (CCD), corresponding to each of colors, red (R), green (G), and blue (B), under the reading surface.

The three color image sensors are arranged along a direction in which the document transporter 7 transports a document (document feed direction). That is, a B sensor, a G sensor, and an R sensor are arranged in this order along the document feed direction from the rear to the front in the document feed direction. Therefore, when the document transporter 7 transports the document, these three color sensors read the document in the order of the B sensor, the G sensor, and the R sensor. A gap having a predetermined length is provided between the B sensor and the G sensor. Similarly, a gap having the same length is provided between the G sensor and the R sensor.

The image former 11 forms (prints) an image on a medium such as a copy sheet based on image data. The image former may use any printing method such as an inkjet printer, a laser printer, and a thermal transfer printer. The image former may be a monochrome printer or a color printer.

The communicator 13 connects to a network. The communicator 13 includes an interface connectable to, for example, a wired local area network (LAN), a wireless LAN, or a long term evolution (LTE) network. When the communicator 13 is connected to a network, the image forming apparatus 1 is connected to other devices and an external network. The communicator 13 may be an interface that performs short-range wireless communication such as near field communication (NFC) or Bluetooth (registered trademark).

The connector 15 connects the image forming apparatus 1 to other devices. For example, the connector 15 is a Universal Serial Bus (USB) interface, and a USB memory or the like is connected to the connector 15. The connector 15 may be an interface such as High-Definition Multimedia Interface (HDMI) (registered trademark) other than the USB interface.

The controller 17 controls the entire image forming apparatus 1. The controller 17 includes one or more control devices and control circuits, and includes, for example, a central processing unit (CPU), which is a processor that executes various types of arithmetic processing, and a system on a chip (SoC). The controller 17 can realize each function by reading out programs stored in the storage 19 to execute processing.

The storage 19 stores various types of programs and various types of data necessary for an operation of the image forming apparatus 1. The storage 19 includes one or more recording devices capable of temporary storage, such as a dynamic random access memory (DRAM), or one or more non-temporary recording devices, such as a solid state drive (SSD) including a semiconductor memory or a hard disk drive (HDD) including a magnetic disk. For convenience of explanation, the storage 19 is described as a single unit, but may be configured as separate devices for each purpose, such as an area used to execute programs (main storage area), an area for saving programs and data (auxiliary storage area), and an area used for caching.

1.2 Relationship between Document Transportation and Scanned Image Distortions

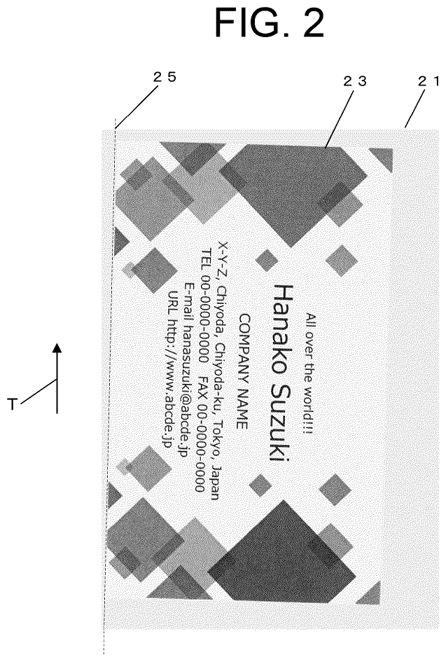

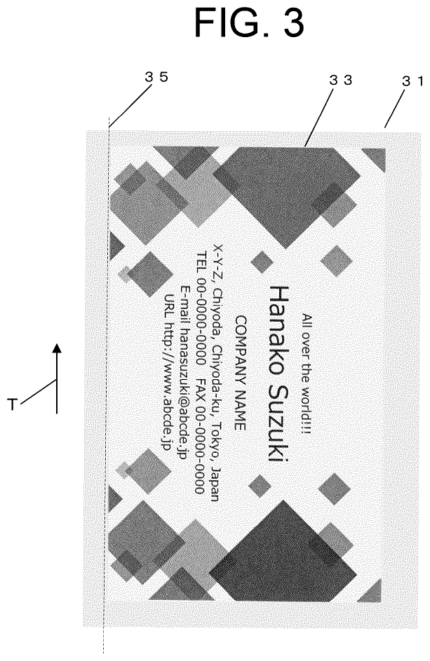

FIG. 2 to FIG. 4 are diagrams for explaining a distortion that occurs in a scanned image when a document undergoes a uniform linear motion and a rotational motion simultaneously in the document transporter 7. FIGS. 2, 3, and 4 illustrate scanned images 21, 31, and 41, respectively. The scanned images 21, 31, and 41 are generated by setting the same business card as a document on the document set table 7a and reading the business card by the image inputter 9. The scanned image 21 includes a document image 23 and a background image, the scanned image 31 includes a document image 33 and a background image, and the scanned image 41 includes a document image 43 and a background image. The business card used as the document is a typical business card, the surface of which is rectangular, and the character strings written on the business card are arranged in a straight line on each line.

Although the scanned images 21, 31, and 41 are generated by scanning the same document, there are differences between the scanned images 21, 31, and 41. It can be seen that distortions increase in the order of the scanned images 21, 31, and 41.

Depending on a state in which the document is transported, there are a case in which no distortions occur, a case in which a slight distortion occurs, a case in which a large distortion occurs, and the like. An ideal transport state is a state in which a document is transported only with a uniform linear motion. However, if the document not only is transported with a uniform linear motion but also rotates, a distortion occurs. As a rotation angle is larger, a larger distortion occurs.

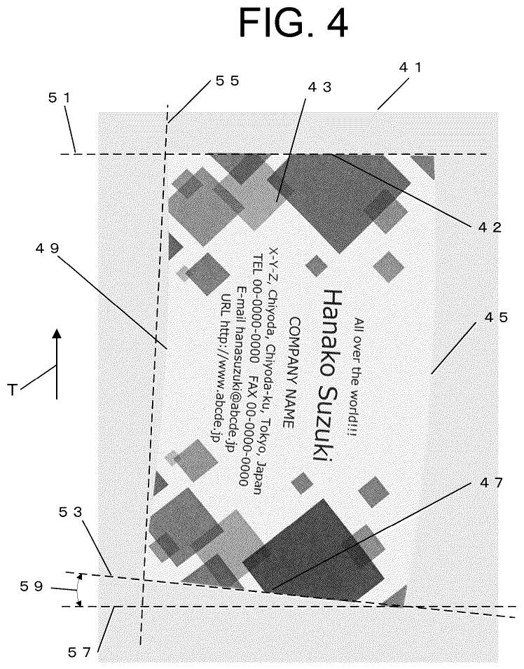

A distortion will be described with reference to FIG. 4. The document image 43 has document edges 42, 45, 47, and 49. Dotted lines 51 and 57 are parallel to the document edge 42, and a dotted line 55 indicates a straight line connecting the left ends of the document edges 42 and 47 (note that in the document image 23, a dotted line 25 corresponds to the dotted line 55, and in the document image 33, a dotted line 35 corresponds to the dotted line 55). The dotted line 51 along the document edge 42 and the dotted line 57 are parallel, and thus, an angle 59 between the dotted lines 53 and 57 is equal to an angle between the dotted lines 51 and 53. That is, the angle 59 is formed between the document edge 42, which is the front edge of the document image 43 in the transport direction, and the document edge 47, which is the rear edge in the transport direction. The angle 59 is called a tilt difference.

The tilt difference differs depending on various conditions related to document transporting, such as a size and a thickness of a document, the number and size variations of documents to be placed, and the adjustment state of the width of the document guide 7a1. In the experiments by the inventors, for example, when documents were ten A4-sized scanned documents, the tilt difference among the documents was approximately 0.3 to 0.5 degrees, whereas in scanning ten business cards having varying sizes, the tilt difference among the business cards was approximately 0.5 to 0.6 degrees. Compared to a case where the documents had A4 size, when the documents had a business card size, a distance (travel length) over which the documents were transported while the image inputter 9 scanned the documents was shorter, and thus, it was found that the curvature due to the tilt difference tended to be larger. Thus, when comparing a case in which the document size is A4 size with a case in which the document size is business card size, for scanned images generated by transporting a document by the document transporter 7, the scanned image generated from a business card sized document is more likely to have noticeable distortion.

### 1.3 Distortion Occurrence Simulation

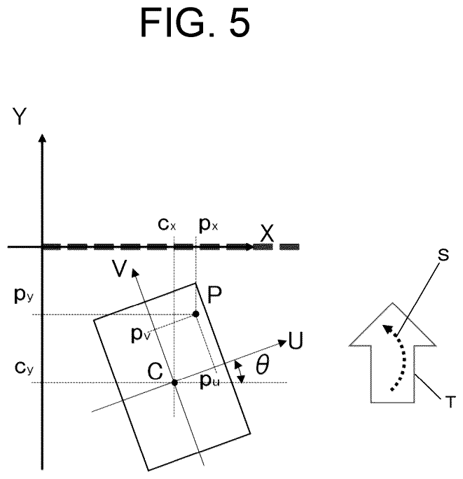

FIG. 5 is a diagram for explaining a simulation of occurrence of a distortion caused by a change in tilt angle of a document while transporting the document. A state in which a document is transported along a transport path by the document transporter 7 is illustrated in the form of the transport path developed on a plane. When the document is transported to the image inputter 9 by the document transporter 7, it is assumed that the document is transported under the following conditions.
C is the document center, cₓ is the x coordinate of the document center C, and c_{y} is the y coordinate thereof. c_{y0} is the initial value of the y coordinate of the document center C.
The document moves linearly at a uniform speed toward an orientation indicated by an arrow in a document feed direction T. At this time, the document center C moves at a uniform speed on a straight line expressed by the following Equation 1.

$$X = {c}_{x} \qquad ( Equation 1 )$$

When t is a time, the y coordinate c_{y} of the document is expressed by the following Equation 2.

$${c}_{y} = t + {c}_{y 0} \qquad ( Equation 2 )$$

First, the document is transported to the document set table 7a with a tilt of an initial angle φ.
As indicated by a dotted line S, the document rotates at a uniform angular velocity ω around the document center C. In such a case, an angle θ of a U-axis with respect to the X-axis is expressed by the following Equation 3.

$$θ = ω t + φ \qquad ( Equation 3 )$$

When the transport mechanism 7b transports the document, while the document center C moves linearly at a uniform speed according to Equation 2 along the document feed direction (the straight line according to Equation 1), the document rotates according to Equation 3.
A line sensor (image sensor) of the image inputter 9 is located on the X-axis, and the line sensor saves a portion of the document overlapping on the X-axis as image data (scanned image).
The document is rectangular, 2a is a length (width) in the lateral direction, and 2b is a length (height) in the longitudinal direction.
A position on the document is expressed by U-V coordinate axes with the document center C being the origin.
A point P on the document is in the range of −a≤u≤a, −b≤v≤b.
The point P on the document is expressed as (Pᵤ, Pᵥ) in the U-V coordinate system.
The point P on the document is expressed as (Pₓ, P_{y}) in the X-Y coordinate system.

In the above case, (Pᵤ, Pᵥ) can be converted into (Pₓ, P_{y}) by the following Equation 4.

$$( \begin{matrix}{p}_{x} \\ {p}_{y} \\ 1\end{matrix} ) = ( \begin{matrix}cos θ & - sin θ & {c}_{x} \\ sin θ & cos θ & {c}_{y} \\ 0 & 0 & 1\end{matrix} ) ( \begin{matrix}{p}_{u} \\ {p}_{v} \\ 1\end{matrix} ) \qquad [ Math . 1 ]$$

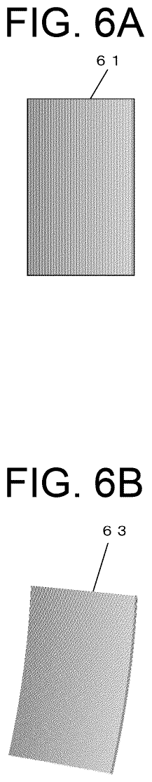

FIG. 6A is a diagram illustrating a document 61 being a business card sized image used as a document in the simulation of FIG. 5. The following values are used as parameters:
cx: 500 pixels
cy0: −600 pixels
ω: −0.0465 degrees/pixel
φ: −5 degrees a: 325
b: 537

FIG. 6B is a diagram illustrating a simulated document image 63 obtained by executing the simulation of FIG. 5 by using the above-mentioned parameters on the document 61 of FIG. 6A. The inventors confirm that in a typical image forming apparatus, when a document is compared with a distorted scanned image actually transported in a document transporter and generated in an image inputter, the simulated document image 63 can adequately reproduce the distortion in the actual scanned image.

### 1.4 Outline of Correction Processing

On the premise that a distortion of a document image occurs as in the above simulation, the outline of the document is calculated as follows based on the document image contained in the scanned image.

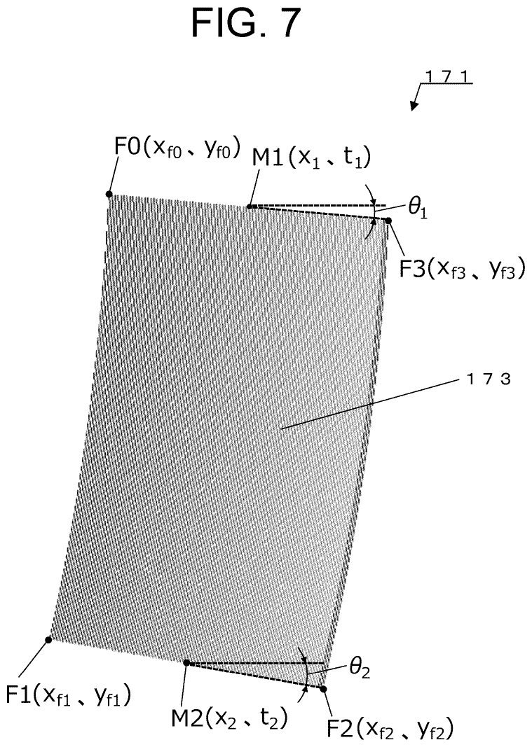

FIG. 7 is a diagram for explaining various types of numerical values that can be acquired from a document image 173 included in a scanned image 171. F₀, F₁, F₂, and F₃ are each the vertices of the four corners of the document image. The coordinates of F₀, F₁, F₂, and F₃ are respectively (x_{f0}, y_{f0}), (x_{f1}, y_{f1}), (x_{f2}, y_{f2}) and (x_{f3}, y_{f3}). M₁ is the midpoint of the line segment F₀F₃, and the coordinates of M₁ are (x₁, t₁). M₂ is the midpoint of the line segment F₁F₂, and the coordinates of M₂ are (x₂, t₂). θ₁ is the angle that the line segment F₀F₃ makes with the X-axis. θ₂ is the angle that the line segment F₁F₂ makes with the X-axis.

Based on these values, the following parameters are calculated:
cx: x-coordinate of document center C-c_{y0}: Initial value of y-coordinate of document center C
ω: Angular velocity of tilt angle
φ: Initial value of tilt angle
a: ½ width of document size
b: ½ height of document size

The parameters are calculated as follows.
(1) Determine the coordinates of the four points F₀ to F₃.
(2) Determine the coordinates of the midpoints M₁ and M₂.
(3) Determine θ₁ and θ₂.
(4) Substitute t₁, t₂, θ₁, and θ₂ into Equation 3 to determine ω and φ.

$$ω = ( {θ}_{2} - {θ}_{1} ) \div ( {t}_{2} - {t}_{1} ) \qquad Equation 5$$

$$φ = {θ}_{1} - ω \times {t}_{1} \qquad Equation 6$$

(5) The coordinate values (pᵤ, Pᵥ) of the midpoint M₁ on the document before distortion are expressed as (0, b). Furthermore, the coordinate values (pᵤ, Pᵥ) of the midpoint M₂ on the document before distortion are expressed as (0, −b). These are substituted into the equation for determining pₓ and p_{y} in Equation 4 to solve the resulting simultaneous equations so that b and cₓ are determined as follows.

$$b = ( {x}_{2} - {x}_{1} ) \div ( sin {θ}_{1} + sin {θ}_{2} ) \qquad Equation 7$$

$${c}_{x} = {x}_{1} + ( {x}_{2} - {x}_{1} ) sin {θ}_{1} \div ( sin {θ}_{1} + sin {θ}_{2} ) \qquad Equation 8$$

(6) The coordinate values (pᵤ, Pᵥ) of the point F₃ on the document before distortion are (a, b). These are substituted into the equation for determining pₓ in Equation 4 to determine a. t₃ is a time when the point on the document, (pᵤ, Pᵥ)=(a, b) corresponding to the point F₃ reaches the line sensor position, and θ₃ is the tilt of the document at the time t₃.

$$a = ( {x}_{f 3} + b \cdot sin {θ}_{3} - {c}_{x} ) \div cos {θ}_{3} \qquad Equation 9$$

At this time, (a, b) is located on the line sensor, and thus, p_{y}=0, and t=yₜ₃, so that c_{y0} is found from Equations 2 and 4 as follows:

$${c}_{y 0} = - a \cdot sin {θ}_{3} - b \cdot cos {θ}_{3} - {y}_{f 3} \qquad Equation 10$$

### 1.5 Operation of Image Forming Apparatus 1: Extraction of Correction Processing Parameter

The controller 17 transports the document set on the document set table 7a to the image inputter 9 by using the transport mechanism 7b. The controller 17 generates a scanner image including the transported document by using the image inputter 9. After the scanner image is generated, the controller 17 transports the document to a discharge tray 7d by using the transport mechanism 7b.

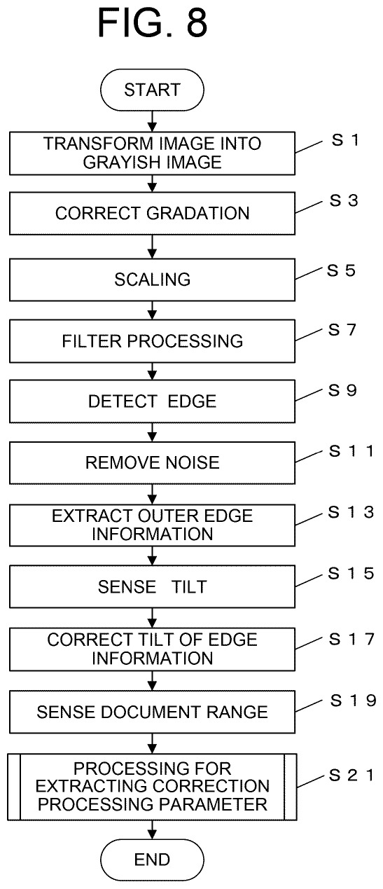

FIG. 8 is a flowchart illustrating processing for sensing a document image from a scanned image data. The controller 17 executes the processing in FIG. 8 on the scanner image generated in the image inputter 9.

The controller 17 changes the scanner image into a grayish image (step S1). Next, the controller 17 performs gradation correction on the grayish scanner image (step S3). Next, the controller 17 scales the gradation-corrected scanner image (step S5). Next, the controller 17 executes filter processing on the scaled scanner image (step S7). Next, the controller 17 detects edges from the filtered scanner image (step S9). Next, the controller 17 removes noise from the detected edges (step S11). Next, the controller 17 extracts outer edge information based on the edges from which the noise is removed (step S13). The processing in step S1 to step S13 is performed on image data. The processing in step S7 to step S13 is carried out separately for extracting edges in the vertical direction and for extracting edges in the horizontal direction.

Next, the controller 17 senses a tilt based on the extracted outer edge information (step S15). Next, the controller 17 corrects the sensed tilt (step S17). Next, the controller 17 senses a document range, based on the edges with the corrected tilt (step S19). An image within the document range is a document image. In step S19, the coordinates of the points F₀ to F₃ which are the four vertices of the document image are determined. Next, the controller 17 executes processing for extracting correction processing parameters (step S21).

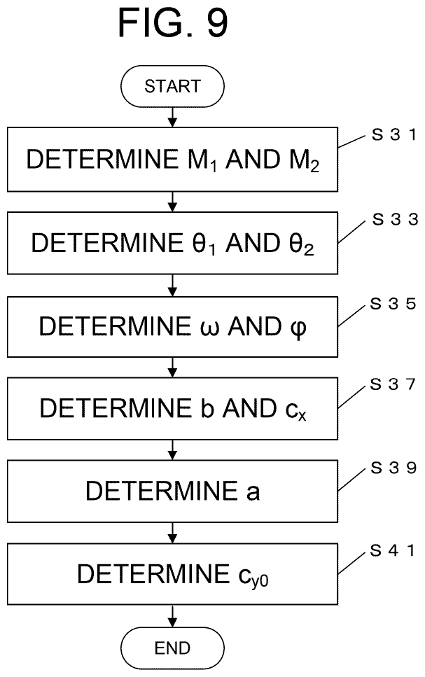

FIG. 9 is a flowchart illustrating processing for extracting a correction processing parameter in step S21. As described above, in step S19, the controller 17 determines the coordinates (x_{f0}, y_{f0}) of the point F₀, the coordinates (x_{f1}, y_{f1}) of the point F₁, the coordinates (x_{f2}, y_{f2}) of the point F₂, and the coordinates (x_{f3}, y_{f3}) of the point F₃. The controller 17 determines the midpoints M₁ and M₂ from these coordinates (step S31). Next, the controller 17 determines θ₁ from the tilts of the line segments F₀F₃, and determines θ₂ from the tilts of the line segments F₁F₂ (step S33). Next, the controller 17 determines ω and φ (step S35). @ can be determined from Equation 5. φ can be determined from Equation 6.

Next, the controller 17 applies x₁, x₂, θ₁, and θ₂ to Equations 7 and 8 to determine b and cₓ (step S37). Next, the controller 17 applies x_{f3}, b, θ₃, and cₓ to Equation 9 to determine a (step S39). Next, the controller 17 applies a, b, θ₃, and yₜ₃ to Equation 10 to determine c_{y0} (step S41).

### 1.6 Image Transformation and Mapping Function

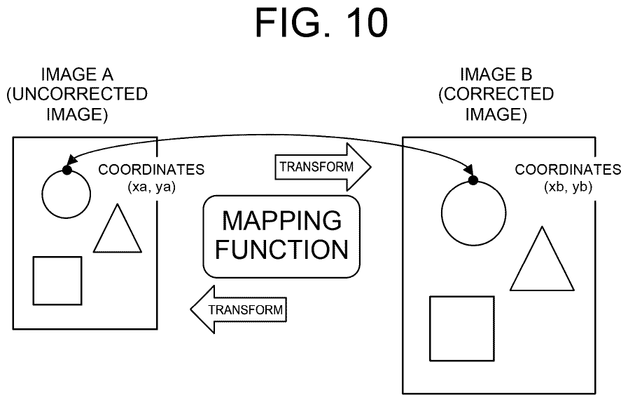

FIG. 10 is a diagram for explaining a relationship between image transformation and a mapping function. As illustrated in FIG. 10, image transformation can be performed using a mapping function. At this time, the mapping function can be changed to perform various image transformations such as rotation, translation, enlargement, and reduction.

Here, an image A is a pre-transformation image, and an image B is a post-transformation image. The coordinates of the image A are (xₐ, yₐ), and the coordinates of the image B are (x_{b}, y_{b}). Generally, image transformation processing using a mapping function can be performed according to the following procedure.
Determine the coordinates before transformation (xₐ, yₐ) corresponding to the coordinates after transformation (x_{b}, y_{b}).
The coordinates before transformation (xₐ, yₐ) are generally not integer values, and thus, the neighboring pixels are determined.
Appropriate interpolation processing is performed based on the pixel values of the neighboring pixels, and the resultant pixel values are used as the pixel values of the coordinates after transformation (x_{b}, y_{b}). Examples of the interpolation processing include nearest neighbor, bilinear, and bicubic.
The above processing is performed for all coordinates of the post-transformation image to determine pixel values.

The correction processing according to the present disclosure is also a type of image transformation using a mapping function. The above-mentioned mapping functions of the distortion caused by the change in tilt angle of the document during transportation are formulated as Equations 2, 3, and 4. Therefore, it is possible to generate a post-transformation image, that is, an image with a distortion corrected, from a pre-transformation image, that is, a distorted scanned image, based on Equations 2, 3, and 4.

### 1.7 Operation of Image Forming Apparatus: Correction Processing

The image forming apparatus 1 performs correction processing based on such a concept on the document image sensed in step S19 of FIG. 8. At this time, the correction processing is performed based on the parameters extracted in the processing for extracting the correction processing parameters illustrated in step S21 of FIG. 8 and FIG. 9.

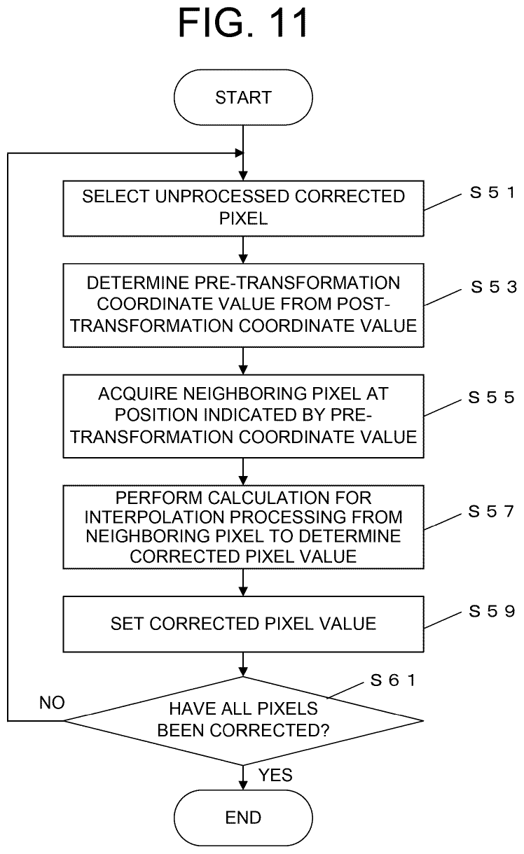

FIG. 11 is a flowchart illustrating processing for correcting a distortion according to the present disclosure. In the flowchart, “correction” or “correct” refers to calculating pixel values of an ideal document image without distortions from pixel values of a document image with distortions. A document image with distortions is an image generated immediately after a document is scanned. “Pre-correction coordinate values” are the coordinate values of pixels of an image with distortions obtained immediately after a document is scanned. “Post-correction coordinate values” are the coordinate values of pixels of an ideal document image without distortions.

The controller 17 selects an unprocessed corrected pixel whose corrected pixel value is determined (step S51). Next, the controller 17 determines, from the coordinate value of that pixel (post-correction coordinate value), the coordinate value (pre-correction coordinate value) indicating the corresponding position on the scanned image where a distortion occurs (step S53). Such a calculation is performed based on the mapping functions according to Equations 2, 3, and 4 formulated above. Next, the controller 17 acquires pixels located around the position indicated by the pre-correction coordinate values (step S55). Next, the controller 17 performs calculations for complementation processing using neighboring pixels to determine a corrected pixel value (step S57). Generally, the pre-correction coordinate values determined in step S53 are not integer values, and therefore, there is usually no pixel having coordinate values that completely match the pre-correction coordinate values. Thus, an interpolation calculation is performed using the neighboring pixels located around the pre-correction coordinate values determined in step S53. Next, the controller 17 sets the determined corrected pixel value (step S59). If there are still unprocessed corrected pixels for which the corrected pixel values are not determined and for which steps S51 to S59 are not performed (No in step S61), the processing returns to step S51; if steps S51 to S59 are performed for all pixels (Yes in step S61), the processing ends.

### 1.8 Effects

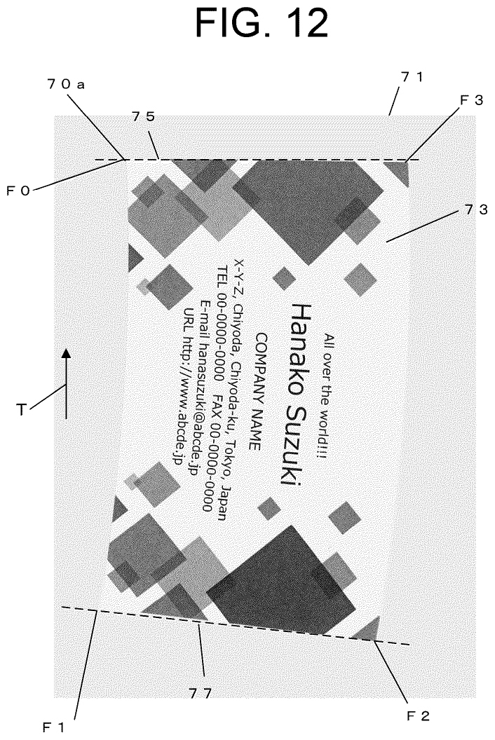

FIG. 12 is a diagram for illustrating an example of a distorted scanned image. A scanned image 71 includes a document image 73 and a background image. An arrow T indicates the transport direction in which the transport mechanism 7b of the document transporter 7 transports the document when the image inputter 9 generates the scanned image 71. The document image 73 has a document edge 75 in the front in the transport direction T, and the document edge 75 is substantially perpendicular to the transport direction T. Further, a document edge 77 is located in the rear in the transport direction T. Due to a distortion that occurs in transporting the document, the document edge 77 is not perpendicular to the transport direction T, as illustrated in FIG. 12.

More specifically, the direction indicated by the arrow T is the positive direction of the Y axis, the right side in the figure perpendicular to the arrow T is the positive direction of the X axis, and the angle rotated counterclockwise is a positive angle. The angle which the document edge 75 makes with the X-axis and the angle which the document edge 77 makes with the X-axis are both referred to as the tilt angle. At this time, the tilt angle of the document edge 75 is approximately −0.68 degrees. The tilt angle of the document edge 77 is approximately −6.53 degrees. The document image 73 has four vertices F0, F1, F2, and F3, arranged counterclockwise from the upper left. The coordinates of the vertex F0 are (334, 207), the coordinates of the vertex F1 are (209, 2273), the coordinates of the vertex F2 are (1484, 2420), and the coordinates of the vertex F3 are (1626, 221). For the sake of convenience, the scanned image 71 has a larger distortion than usual.

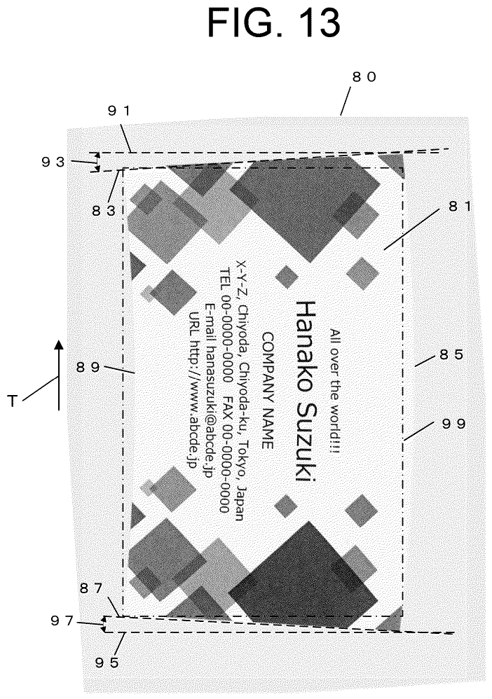

General correction processing consists of rotation processing and cropping processing. FIG. 13 is a diagram for explaining a scanned image 80 in which rotation processing, which is a part of general correction processing, is applied to the scanned image 71 in FIG. 12. In the rotation processing in the general correction processing, the correction is performed by rotating the document image 73 based on the average of the tilt angle of the document edge 75 and the tilt angle of the document edge 77. That is, the average (approximately −3.605 degrees) of the tilt angle (approximately −0.68 degrees) of the document edge 75 and the tilt angle (approximately −6.53 degrees) of the document edge 77 is determined, and the document image 73 is rotated so that the tilt angles of the document edges 75 and 77 both become the average (approximately −3.605 degrees). Therefore, in the corrected scanned image 80, tilt angles 93 and 97 of document edges 83 and 87 corresponding to the document edges 75 and 77, respectively, are both the average (approximately −3.605 degrees). In the subsequent cropping processing, a rectangular area 99 indicated by a dashed line is cropped from the rotated scanned image 80.

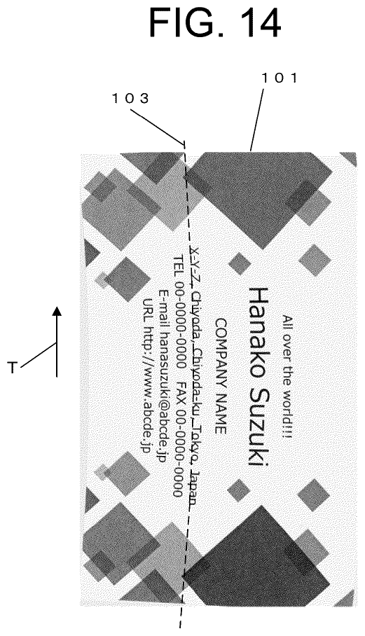

FIG. 14 is a diagram for explaining a scanned image obtained by applying cropping processing to the scanned image applied with the rotation processing in FIG. 13. By the above-mentioned rotation processing and cropping processing, the shape of the business card in a corrected document image 101 is adjusted to a rectangular shape without distortions.

However, due to such cropping processing, the area of a document image 81 sandwiched between the document edge 83 and the rectangular area 99 is lost from the corrected document image 101. Similarly, the area of the document image 81 sandwiched between the document edge 87 and the rectangular area 99 is lost from the corrected document image 101.

Furthermore, the document edge 85 in FIG. 13 is a curved line bulging out toward the right in the figure, and thus, as a result of cutting out the document image 81 with the rectangular area 99, a part at the right side of the document image 81 in the figure is cut off. On the other hand, a document edge 89 also curves to bulge out toward the right in the figure, and thus, the rectangular area 99 includes an area not corresponding to the document image on the left side in the figure. Therefore, the corrected document image 101 includes additional areas not corresponding to the document. Moreover, the corrected document image 101 loses a part of the area corresponding to the document.

In the corrected document image 101, distortions of various types of images and character strings printed on the business card are corrected. For example, as indicated by a dotted curve 103, the arrangement of the character strings in the business card remains distorted.

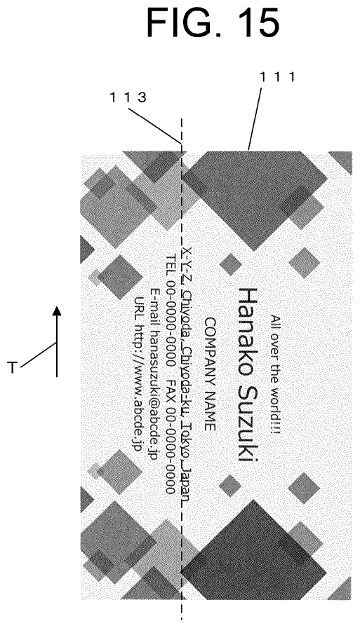

FIG. 15 is a diagram for explaining a corrected document image 111 obtained by applying the correction processing according to the present disclosure to the scanned image in FIG. 12. As described above with reference to FIG. 10, in the correction processing according to the present disclosure, a distorted document image generated by scanning a document is considered as a document image obtained as a result of mapping the document. That is, the document is understood as the inverse mapping of the document image. Thus, the four document edges of the image 111 correspond to the four document edges of the document, respectively, so that areas that are not in the document are not added to the document image, and areas that are in the document are not lost from the document image, as in conventional correction processing.

In the corrected document image 111, distortions of various types of images and character strings printed on the business card are also corrected. For example, in the corrected document image 111, as indicated by the dotted curve 113, the character strings on the business card are arranged in a substantially straight line.

### 2. Modification

The present disclosure is not limited to the above-described embodiments and modifications, and various changes are possible. In other words, embodiments obtained by combining technical means appropriately modified within the scope not deviating from the gist of the present disclosure are also included within the technical scope of the present disclosure.

The distortion correction in the present disclosure is effective when a document is small, particularly when a document is the size of a business card. Therefore, it is sufficient that the controller 17 corrects a distortion according to the present disclosure when the document size is the size of a business card. In such a case, a sensor for acquiring the size of the document may be provided on the document set table 7a, and the controller 17 may acquire the document size from the document set table 7a, or may acquire the document size based on the document size setting input via the operation acceptor 5.

Programs running on each device in the embodiments are programs that control the CPU and the like (programs that cause a computer to function) to realize the functions of the above-described embodiments. Information handled in these devices is temporarily accumulated in a temporary storage device (e.g., a random access memory RAM)) during processing, and is then stored in various types of storage devices such as read only memories (ROMs) and HDDs, and is read, modified, and written by the CPU as necessary.

Here, the recording medium for storing the programs may be any of a semiconductor medium (e.g., a ROM or a non-volatile memory card), an optical recording medium-magneto-optical recording medium (e.g., a Digital Versatile Disc (DVD), a Magneto Optical Disc (MO), a Mini Disc (MD), a Compact Disc (CD), and a Blu-ray (BD) (registered trademark) Disc), a magnetic recording medium (e.g., a magnetic tape and a flexible disk), etc. In addition, the functions of the above-described embodiments are realized not only by executing the loaded programs, but the functions of the present disclosure may also be realized by performing processing in cooperation with an operating system, other application programs, etc., based on the instructions of the program.

In distributing the programs on the market, the programs can be stored on a portable recording medium and distributed, or transferred to a server computer connected via a network such as the Internet. In such a case, it goes without saying that the storage device of the server computer is also included in the present disclosure.

While there have been described what are at present considered to be certain embodiments of the disclosure, it will be understood that various modifications may be made thereto, and it is intended that the appended claims cover all such modifications as fall within the true spirit and scope of the disclosure.

What is claimed is:

1. An image forming apparatus, comprising:
one or more controllers;
an image inputter that optically reads a document; and
a document transporter that transports the document, wherein
the one or more controllers
generate a document image obtained by creating an image of the document after the image inputter reads the document while the document transporter transports the document,
specify a mapping function correlating each coordinate of the document with each coordinate of the generated document image, and
correct a distortion of the document image by transforming the document image for the mapping function.

2. The image forming apparatus according to claim 1, wherein the mapping function indicates a mapping from the document to the document image generated by reading the document assumed to rotate while moving in a uniform linear motion along a direction of the transport.

3. The image forming apparatus according to claim 1, wherein the one or more controllers
determine neighboring pixels in the document image corresponding to each pixel in the document, and
determine a pixel value of each pixel in the document, based on pixel values of the neighboring pixels.

4. The image forming apparatus according to claim 1, wherein the one or more controllers
perform a correction of the distortion of the document image when the document is a size of a business card.

5. The image forming apparatus according to claim 1, wherein the one or more controllers
calculate a parameter for a correction of the distortion of the document image, based on midpoints of two opposing sides and tilts of the two opposing sides in the document image.

6. A method for controlling an image forming apparatus comprising:
generating a document image obtained by creating an image of the document after the document is read while being transported;
specifying a mapping function correlating each coordinate of the document with each coordinate of the generated document image; and
correcting a distortion of the document image by transforming the document image for the mapping function.
